(19) United States
(12) Patent Application Publication
(10) Pub. No.: US 2026/0076282 A1
(43) Pub. Date: Mar. 19, 2026

(54) APPARATUS AND METHOD FOR CONVERSION OF CONVENTIONAL AGRICULTURAL EQUIPMENT AND IMPLEMENTS TO ENABLE FULL AUTONOMOUS OPERATION

(71) Applicant: MACH, INC., ELY, IA (US)

(72) Inventors: RHETT W. SCHILDROTH, NORTH LIBERTY, IA (US); COLIN JOSH HURD, AMES, IA (US); SAGE SCHILDROTH, NORTH LIBERTY, IA (US)

(73) Assignee: MACH, INC., ELY, IA (US)

(21) Appl. No.: 19/328,183

(22) Filed: Sep. 14, 2025

Related U.S. Application Data
(60) Provisional application No. 63/694,882, filed on Sep. 15, 2024.

(51) Int. Cl. A01B 69/04

(52) U.S. Cl. CPC A01B 69/008

(57) ABSTRACT

A toolkit and assembly for modifying conventional agricultural equipment, including main or primary equipment and attachments and implements that are configured with such equipment, is provided within a framework having hardware and software elements. The toolkit and assembly, and associated framework, enable conversion of such agricultural equipment for autonomous operation and control. The toolkit and assembly includes components for gear shifting, steering control, brake actuation, and actuation of attachments and implements, and also includes components for detecting obstacles in a path of either the agricultural equipment and associated attachments and implements, and a system for override protection prior to collision with an obstacle.

### CROSS-REFERENCE TO RELATED PATENT APPLICATION(S)

This patent application claims priority to U.S. provisional patent application 63/694,882, filed on Sep. 15, 2024, the contents of which are incorporated in its entirety herein. In accordance with 37 C.F.R. § 1.76, a claim of priority is included in an Application Data Sheet filed concurrently herewith.

### FIELD OF THE INVENTION

The present invention relates to the field of precision agriculture. Specifically, the present invention relates to an approach to modifying existing conventional agricultural equipment to enable fully autonomous, software-based operation and control.

### BACKGROUND OF THE INVENTION

Autonomous operation of equipment is becoming increasingly prevalent in the field of agriculture. Such autonomous operation has many challenges unique to the industry, and is currently more or less limited in scope to vehicles serving as main or primary equipment such as tractors (vehicles generally used to pull other machines) and combines (vehicles used for specific functions such as cutting, threshing, and cleaning grains, and for harvesting crops). Even for such main or primary equipment, there remains serious challenges to automation, such as providing modifications to vehicles that are already in use to enable autonomous operation.

Autonomous operation of attachments and implements configured with such main or primary equipment is even more challenging, at least because of general complexities associated with integration of autonomous operation of such attachments and implements together with the modifications needed for autonomous operation of the main or primary equipment. The environments in which such attachments and implements are to be used also present automation and integration problems. For example, existing technology lacks a standardized solution in which different attachments and implements, and the particular uses for them, can be successfully and safely integrated together with main or primary equipment in manner that minimizes in-field complications and issues.

### BRIEF SUMMARY OF THE INVENTION

The present invention provides a toolkit and assembly for mechanical modification of such agricultural equipment that enables full software-based autonomous operation and control. The toolkit and assembly may be embodied in one or more systems and methods that provide approaches for converting various hardware elements of agricultural equipment to enable software-based integration of attachments and implements with main and primary vehicles to enable autonomous operation and control.

The approaches include, in one exemplary embodiment thereof, modification of a manual transmission in a vehicle, such as an agricultural tractor, to enable electronic gear shifting for autonomous operation. In such a situation, the toolkit and assembly integrates a linear actuator and a rotational actuator to interface with existing transmission linkages. The actuators provide linear and axial movement to select gear positions. This dual-actuator arrangement replaces manual lever inputs, allowing drive-by-wire control without replacing the core transmission assembly.

Regardless, the approaches of the present invention are applicable to any agricultural equipment that is mechanically operable in some manner to perform particular functions in an agricultural environment. Such agricultural equipment may also include an attachment or implement, in conjunction with other main or primary equipment, such as a tractor or other vehicles, and therefore the present invention is applicable to both general agricultural equipment operating by itself, as well as with any attachments or implements coupled thereto. For example, these types of attachments and implements may include, but are not limited to, boom mowers, pulled or mounted mowers, front bucket loaders, and snow blowers or blades. It is to be understood that such equipment may itself be self-propelled machines capable of specific operation, and therefore not necessarily capable of being coupled to another machine. It is to be further understood that the present invention is therefore applicable to any type of agricultural equipment having specific mechanical features for performing specialized activities or tasks.

Objectives, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a system diagram illustrating various elements and functions of a framework for a toolkit and assembly according to the present invention;

FIG. 2 is a flow chart illustrating a process for performing the framework for a toolkit and assembly of FIG. 1 according to the present invention;

FIG. 3 is a flow diagram illustrating several examples of functions that are possible within the framework for a toolkit and assembly of FIG. 1, and process of FIG. 2, according to the present invention;

FIG. 4 is a diagram of components mounted to the front or rear of an implement or agricultural equipment, according to one embodiment of the present invention;

FIG. 5 is a diagram of an exemplary modification of agricultural equipment for gear control thereof, according to one embodiment of the present invention;

FIG. 6 is a flowchart illustrating steps in an algorithm for providing a speed control process for agricultural equipment, according to one embodiment of the present invention;

FIG. 7 is a diagram of an exemplary modification of agricultural equipment for steering control thereof, according to one embodiment of the present invention;

FIG. 8 is a diagram of an exemplary modification of agricultural equipment for hydraulic control thereof, according to one embodiment of the present invention;

FIG. 9 is a hydraulic schematic illustrating hydraulic remote control, according to one embodiment of the present invention;

FIG. 10 is a diagram illustrating connection points and various elements that are associated with the implements, according to one embodiment of the present invention;

FIG. 11 is a diagram illustrating an enclosure for mount electronics to an implement, according to one embodiment of the present invention;

FIG. 12 is a flow diagram illustrating steps in a process for analyzing data from an electronic inertial measurement unit for the framework of the present invention, according to one embodiment thereof;

FIG. 13 is a diagram illustrating an encoder for measuring transmission speed of agricultural equipment, according to one embodiment of the present invention;

FIG. 14 is a diagram illustrating placement of a front-facing sensor for observing the front and sides of agricultural equipment to determine if obstacles are present, according to one embodiment of the present invention;

FIG. 15 is a diagram illustrating a position of an actuator for gear control, according to one embodiment of the present invention; and

FIG. 16 is a diagram illustrating a mounting of a linear magnetic wheel sensor for steering control, according to one embodiment of the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The present invention is, as noted above, a hardware and software toolkit for autonomous operation and control of agricultural equipment. This toolkit, embodied in one or more systems and methods, provides approaches for modifying agricultural equipment to enable fully autonomous software operation of both main and primary agricultural equipment, as well as control of attachments and implements that are configured with such equipment. The toolkit may be thought of as an assembly comprised of hardware and software elements that allow conversion of various mechanical aspects of agricultural equipment, together with the mechanical elements coupled thereto as attachments and implements, into autonomously operated and controlled machines.

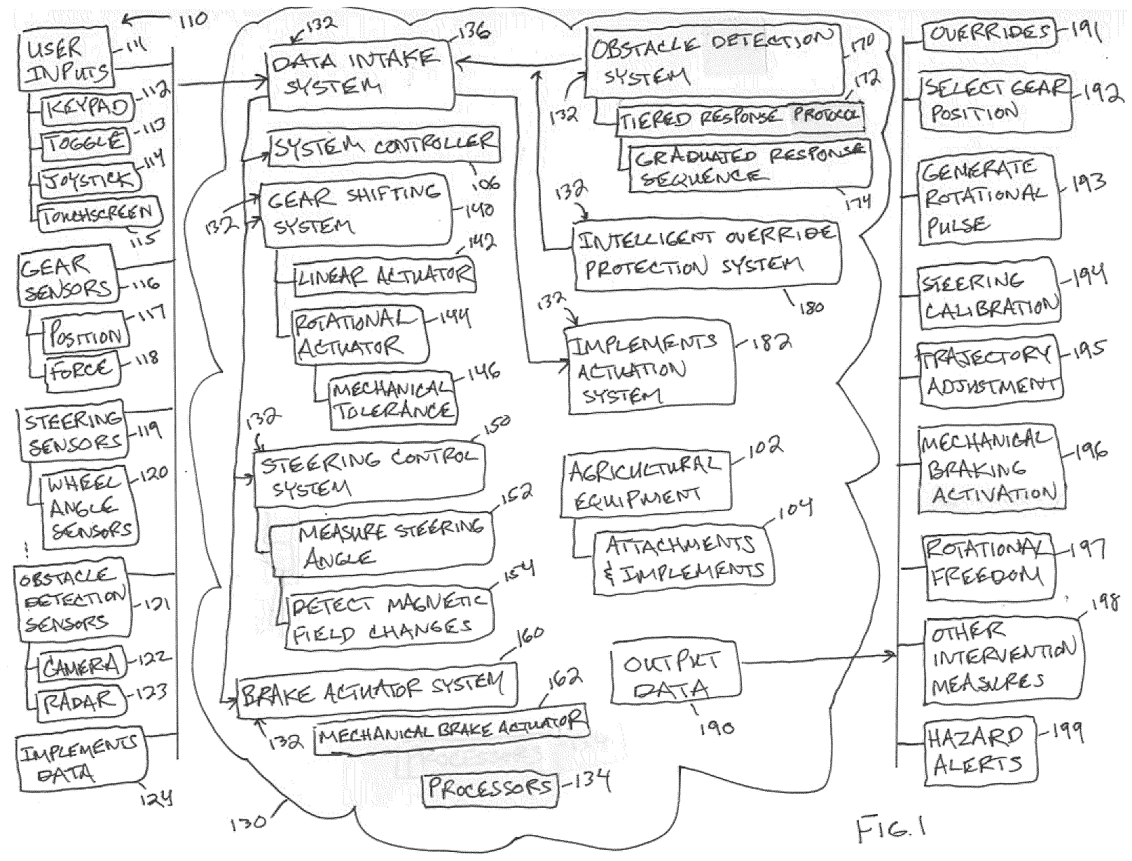

The toolkit and assembly of the present invention may be implemented within a framework 100 comprised of those hardware and software elements, as shown in the exemplary systemic diagram of FIG. 1. These hardware and software elements provide for one or more processes which enable and complement the mechanical modifications discussed herein in the conversion of the agricultural equipment from manual operation and control to fully-automated operation and control. These hardware and software elements and associated processes are themselves embodied within one or more systems and/or methods that are performed in a plurality of data processing elements 132, or modules or the like, which are components within a computing environment 130. These data processing elements 132 may be configured to run within external cloud computing environments (and accessed therefrom by the framework 100), and also may be configured to run locally on devices hosting the framework 100, such as on mobile computing devices, “smart” phones, earphones or earbuds, on other wearable, internet-enabled devices such watches and eyeglasses, and in automotive platforms. Still further, one or more of the data processing elements 132 may be configured to run within, and executed on, edge computing environments and be responsive to natural language instructions, either verbal, written, or gesture-based. One or more processors 134 may be configured to execute program instructions or routines to perform the elements, modules, components, and functions described herein that together comprise and are embodied within the plurality of data processing modules. The words “element” and “elements”, and “module” and “modules” as used herein, may refer to (and the data processing elements 132 may themselves comprise, at least in part) logic embodied in hardware or firmware, or to a collection of software instructions, written in a programming language, such as, for example, Java, Python, C, or assembly. One or more software instructions for such modules may be embedded in firmware. It will be appreciated that the functional data processing elements 132 may include connected logic modules, such as gates and flip-flops, and may include programmable modules, such as programmable gate arrays or processors. The data processing elements 132 described herein may be implemented as either software and/or hardware modules and may be stored in a storage device. It is to be additionally understood that the data processing elements 132, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function.

FIG. 1 as noted above is an exemplary systemic diagram illustrating various aspects of the hardware and software elements comprising the framework 100 of the present invention. The toolkit and assembly are provided within the framework 100 for modification of an autonomous operation of agricultural equipment 102 and attachments and implements 104 coupled thereto, in which various types of input data 110 enables operations such as gear shifting 140, steering control 150, and brake actuation 160, all of which are subject to further input and adjustment from both an obstacle detection system 170 and an intelligent override protection system 180, all of which are to be described in further detail herein.

The framework 100 of the present invention ingests, receives, requests, or otherwise obtains input data 110 of different types, and from different sources. The data processing elements 132 may include a data intake system 136 that governs or controls intake of the input data 110; for example, this may occur via one or more application programming interfaces (APIs) or via other interfaces designed to capture and provide input data 110 for the modification toolkit described herein. Input data 110 may include user inputs 111 that provide instructions for operating agricultural equipment 102 and attachments and implements 104 in a drive-by-wire manner of control, without having to replace core mechanical assemblies. User inputs 111 may be provided, for example, via keypad 112, toggle switch 113, joystick 114, or touchscreen 115, or any other manner of entering information by a user. This may occur via an interface on a device such as a computer, tablet, or smart or intelligent device such as a phone or watch.

Input data 110 for autonomous drive-by-wire control and operation may also be obtained readings collected from various sensors deployed with agricultural equipment 102 and attachments and implements 104. These include gear sensors 116, such as sensors that monitor and track position 117 (e.g., Hall-effect or optical encoders), and sensors that monitor and track force 118 (e.g., strain gauges). Such gear sensors 116 are mounted on actuators and linkages as described below with respect to gear shifting system 140, and detect the exact position of a shift mechanism and applied forces. Input data 110 from gear sensors 116 signal a system controller 106 when minor rotations (e.g., 1-5 degrees) are required, for example for gear meshing.

Other types of sensors include steering sensors 119, such as wheel angle sensors 120 that utilize a linear magnetic strip or array to directly measure steering angle. Such wheel angle sensors 120 mount a linear magnetic scale along a straight path parallel to steering linkage to overcome errors associated with conventional sensors as described further below with regard to the steering control system 150.

Other input data 110 may be obtained from obstacle detection sensors 121, such as cameras 122 and radar systems 123. Such obstacle detection sensors 121 provide signals for the system controller 106 from the obstacle detection system 170 to adjust the control and operation of the agricultural equipment 102 and/or attachments and implements 104 where an obstacle has been detected. Cameras 122 provide vision-based imaging and may include a single camera, a stereo camera, and multiple cameras (collecting either still images or video images). Radar systems 123 may include conventional ranging systems, or other radar and radar-like systems such as antenna arrays, Lidar systems, and frequency-modulated continuous-wave (FMCW) systems. Other types of sensors for collecting input data may also be used in the present invention, either alone or in conjunction with other sensors, such as acoustic sensors and sonic sensors. Still further, input data 110 may also include inertial measurement unit (IMU) data from inertial measurement units such as gyroscopes and accelerometers onboard agricultural equipment 102 for determining orientation relative to the ground.

Other input data 110 may be included, such as implements data 124, that relates specifically to the attachments and implements 104. These include the type of attachment or implement 104, including parameters that define its operational capabilities and capacity, and information collected from sensors associated with such attachments and implements 104. This implements data 124 is managed, as other input data 110, by data intake system 136 and system controller 106.

Implements data 124 may define, for example, characteristics of the attachment or implement 104 relative to the agricultural equipment 102 with which it is being operated. This includes spatial information such as orientation and distance relative to the agricultural equipment 102, and other information such as weight of the attachment or implement 104 in different operational positions, and height, width, and depth of the attachment or implement 104. Attachments and implements 104 may include, as described below, one or more actuators than enable automated control thereof, and to which the one or more sensors may be coupled.

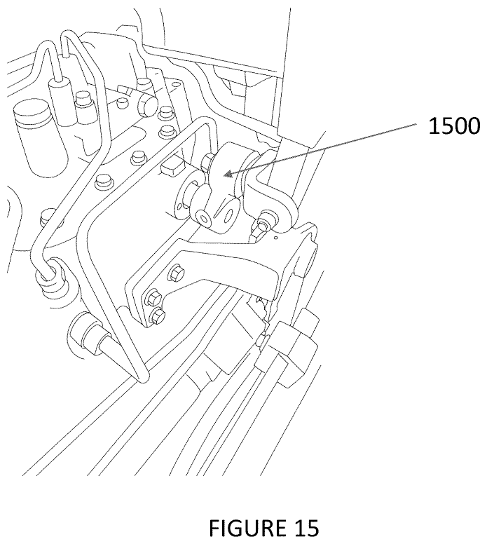

The gear shifting system 140 of the framework 100 provides elements of the toolkit for modifications of transmission systems in agricultural equipment 102. The gear shifting system 140 performs, for example, an electronic conversion of manual transmission in such agricultural equipment 102 (such as for example in an agricultural tractor, combine, or harvester), to enable electronic gear shifting for autonomous operation. The gear shifting system 140 enables this modification of a manual transmission by integrating a linear actuator 142 and a rotational actuator 144 to interface with existing transmission linkages. The linear actuator 142 and a rotational actuator 144 provide linear and axial movement to select gear positions. This dual-actuator setup replaces manual lever inputs, allowing drive-by-wire control without replacing the core transmission assembly. FIG. 15 illustrates a position 1500 of an actuator (which may either or both of the linear actuator 142 or the rotational actuator 144) according to one embodiment of the toolkit and assembly within the framework 100 of the present invention.

Gear selection is facilitated through electronic inputs, such as a keypad 112, toggle switch 113, joystick 114, or touchscreen interface 115 mounted in the vehicle's cabin or remotely via wireless communication for autonomous control. These inputs transmit signals to a central system controller 106, which coordinates the actuators. For instance, pressing a keypad button labeled “3” would command the linear actuator 142 to position the shift fork into the third gear slot, followed by rotational adjustment if needed. This eliminates physical levers, reducing operator fatigue in manual modes and enabling seamless integration with autonomous navigation systems.

To accommodate gear misalignment common in manual transmissions, the rotational actuator 144 incorporates deliberate mechanical ‘slop’ or tolerance 146, such as a compliant coupling or spring-loaded joint with, for example, 5-10 degrees of play. This feature, applied at an interface point (e.g., near pivoting linkage arms), allows for minor self-adjustments during engagement. If gears fail to mesh due to speed mismatch, the mechanical tolerance 146 permits slight rotational freedom, preventing binding and extending component life.

Sensors may be integrated for precise gear engagement. Position 117 sensors (e.g., Hall-effect or optical encoders) and force 118 sensors (e.g., strain gauges) are mounted on the linear actuators 142, rotational actuators 144, and associated linkages. These detect the exact position of the shift mechanism and applied forces, signaling the system controller 106 when minor rotations (e.g., 1-5 degrees) are required for gear meshing. For example, if force feedback indicates resistance, the system controller 106 automatically applies a brief rotational pulse. In the context of the transmission area, sensors may be attached to the exposed bolts and arms, providing real-time data to ensure reliable shifting under varying loads, such as in off-road autonomous driving.

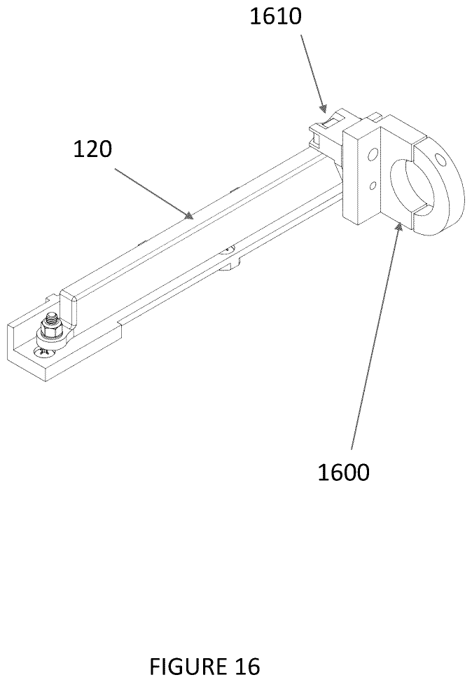

The steering control system 150 of the framework 100 provides elements of the toolkit for modifications that enable steering of the agricultural equipment 102. The steering control system 150 includes a linear magnetic wheel angle sensor 120 that utilizes a linear magnetic strip or array to directly measure steering angle 152. This arrangement overcomes limitations of traditional linkage-based systems. In agricultural vehicles such as tractors, where precise steering is critical for autonomous path-following, conventional sensors rely on mechanical linkages that trace an arc, introducing parallax errors and wear over time. The wheel angle sensor 120 mounts a linear magnetic scale along a straight path parallel to the steering linkage. FIG. 16 illustrates the mounting of a linear magnetic wheel sensor 120 according to one embodiment of the present invention, where a magnet bracket 1600 is attached to a steering cylinder. The wheel angle sensor 120 operates in conjunction with a magnet 1610 to serve as the magnetic strip or array that directly measures the steering angle 152.

This provides a direct measurement mechanism, in which a magnetic reader head, fixed to the moving steering component, slides along the linear scale, detecting changes in magnetic field 154 to compute the angle via trigonometric conversion (e.g., angle θ=arcsin(displacement/radius)). This straight-line measurement eliminates arc-induced inaccuracies, achieving sub-degree precision. Calibration involves mapping linear displacement to angular output, stored in an onboard processor of the system controller 106. For autonomous applications, this wheel angle sensor 120 feeds data to the vehicle's control system, enabling accurate trajectory adjustments without the cumulative errors from linkages.

The brake actuator system 160 of the framework 100 provides elements of the toolkit for modifications that enable braking of the agricultural equipment 102. The brake actuator system 160 includes a compact mechanical brake actuator 162 for fail-safe operation. The mechanical brake actuator 162 is designed for retrofitting existing hydraulic or mechanical braking systems in vehicles transitioning to drive-by-wire autonomy. The mechanical brake actuator 162 remains compact to avoid obstructing human operators, preserve the original braking architecture, and ensure safety by defaulting to brake engagement in failure modes.

The mechanical brake actuator 162 also allows for an overall compact design and non-invasive integration with the existing assembly. The mechanical brake actuator 162 includes a motor, gear (or series of gears), and a chain. As the motor is rotated, the chain pulls back the brake pedals. This allows freedom of movement for a human operator to also push the brake pedals, as the chain would simply flex out of the way and not prohibit motion. A torsion spring may be added that rotates the gear(s) and engages the brake pedals when there is no power to the brake actuator system 160. When powered, rotational force applied by the motor disengages the brakes to release them.

The framework 100 of the present invention also includes an implements actuation system 182. The implements actuation system 182 is coupled to the attachment or implement 104 that is itself coupled to the agricultural equipment 102. The implements actuation system 182 includes one or more mechanical actuators that enable the automated control of the attachment or implement 104, and one or more sensors that provide information characterizing at least an orientation and performance of the attachment or implement 104 relative to the agricultural equipment 102. Depending on the type of attachment or implement 104, the one or more mechanical actuators may take many forms; signals generated by the signal controller 106 impact these mechanical actuators to perform some movement and control of the attachment or implement 104 for autonomous operation.

For example, in the case of a blade mounted to the front or rear of the agricultural equipment 102, the one or more mechanical actuators may raise or lower the blade to move snow, level a gravel driveway, or otherwise modify a surface profile. For pulled or mounted implements 104 such as mowers, tillage tools, or planters, the one or more mechanical actuators may control depth or height to maintain consistent ground engagement. Mounted implements 104 may also be automatically adjusted to compensate for dynamic changes in vehicle roll and pitch, detected via inertial measurement units or tilt sensors, ensuring a consistent working depth or angle even on uneven terrain. In another example, an implement 104 such as a sickle-bar cutting device may be raised, lowered, or angled to maintain a desired cutting height across variable field conditions. These control functions are enabled by sensors coupled to the implements 104 that detect position, orientation, and loading conditions, and by actuators that respond in real time to commands from the system controller 106.

Through these mechanisms, the implements actuation system 182 allows diverse agricultural attachments and implements 104 to be autonomously manipulated in coordination with vehicle movements, thereby enabling consistent, precise, and adaptive operation in a wide range of agricultural and non-agricultural applications.

The framework 100 of the present invention also integrates both an obstacle detection system 170, and an intelligent override protection system 180. The obstacle detection system 170 functions as an active safety layer that supplements operator control, and operates regardless of whether the agricultural equipment 102 and the attachments and implements 104 are operated through direct manual driving or remote control operation.

The obstacle detection system 170 maintains continuous operation regardless of a selected control mode (manual or automated). In a manual driving mode, the obstacle detection system 170 functions as an advanced driver assistance system (ADAS), providing real-time hazard alerts and intervention capabilities. During remote control operation, the obstacle detection system 170 acts as a supervisory safety layer, monitoring for obstacles that may not be visible to the remote operator due to camera limitations, network latency, or restricted viewing angles.

The obstacle detection system 170 includes a detection and response hierarchy, by implementing a tiered response protocol 172 based on obstacle proximity, approach velocity, and operational mode. Upon detecting a potential collision hazard, the obstacle detection system 170 initiates a graduated response sequence 174. Initial warnings are provided through visual and auditory alerts to the operator, whether in-vehicle or at the remote control station. If the operator fails to respond appropriately, the obstacle detection system 170 progresses to active intervention measures.

The obstacle detection system 170 may include one or both of imaging systems and ranging systems that, either alone or in combination, operate to detect obstacles in the path of the agricultural equipment 102 and the attachments and implements 104. Imaging systems include, as noted above, cameras 122 and other vision-based elements for capturing images. Ranging systems include those devices that use radio waves to determine the range, velocity, and angle of objects (such as radar systems 123) and those that emit laser pulses and measure the time it takes for the reflected light to return (such as in LiDAR systems).

The intelligent override protection system 180 is a feature of the toolkit of the present invention which enables the obstacle detection system 170 to temporarily override operator inputs to prevent impact in response to an imminent collision with a detected obstacle. This override function operates through the agricultural vehicle's electronic control systems, modulating throttle, brake, and steering inputs as necessary for the agricultural equipment 102, as well as inputs for operation of attachments and implements 104. The override duration is minimized to maintain operator authority while ensuring collision avoidance.

In a manual driving mode, the override manifests as resistance in the steering wheel when the driver attempts to steer toward an obstacle, automatic speed reduction when approaching obstacles at unsafe velocities, emergency braking, and operation when collision is imminent. In remote control operation, the intelligent override protection system 180 intercepts and modifies control commands before they reach the vehicle and implement actuators, ensuring that potentially dangerous commands are filtered or modified to maintain safe operation.

The framework 100 of the present invention is capable of generating many types of output data 190. These include overrides 191 from the intelligent override protection system 180, which itself further includes overrides 191 of the throttle, braking, and steering systems of at least the agricultural equipment 102. Overrides 191 are also possible for the movement and operation of the attachments and implements 104.

Other output data 190 includes signals for remote operation, such as selecting a gear position 192, generating a rotational pulse 193 for gear meshing and engagement, steering calibration 194, trajectory adjustments 195, actuation of mechanical braking 196, limitations for enablement of rotational freedom 197, and other intervention measures 198, in either a manual driving mode or in remote control operation, depending on the needs of the operator. Still further, output data 190 may include hazard alerts 199, for example when the toolkit enables system function as an advanced driver assistance system (ADAS) in manual driving mode.

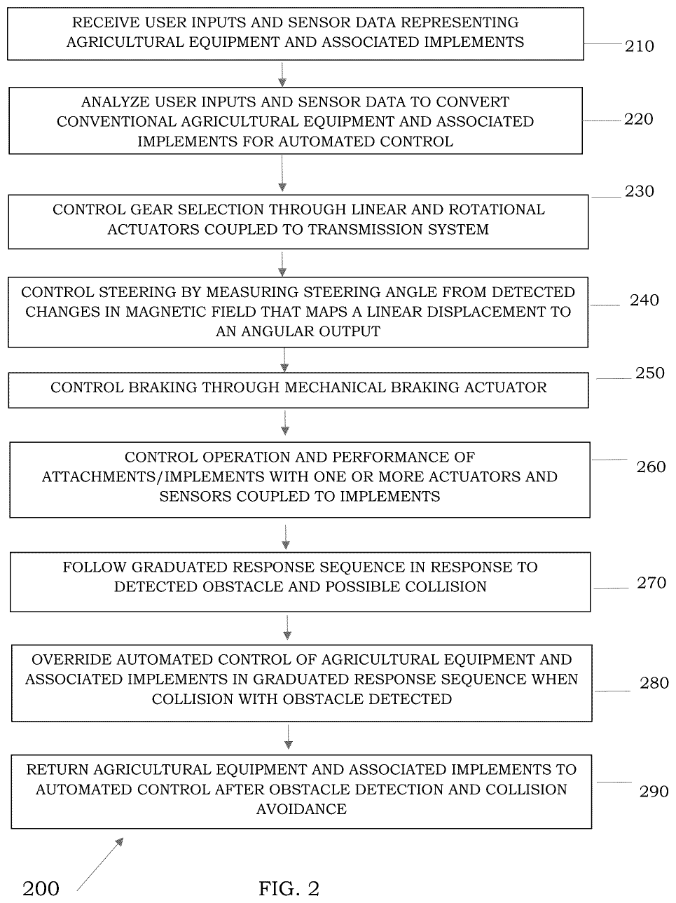

### FIG. 2

FIG. 2 is a flowchart illustrating steps in a process 200 of performing the framework 100 according to one aspect of the present invention. The framework 100 is initialized in step 210 by receiving user inputs that represent an automation of agricultural equipment 102 and associated attachments and implements 104 that are coupled thereto. Also at step 210, other inputs may be received, such as sensor data for various systems comprising the toolkit performed within the framework 100. At step 220, these user inputs and sensor data are analyzed to convert conventional agricultural equipment 102 and the attachments and implements 104 coupled thereto for automated control and operation.

This is accomplished by multiple steps in the process 200. These steps include steps 230 through 260, which need not be performed in order. They may be performed in any order, and may be performed simultaneously with each other. The same applies to steps 270-290, which may also be performed simultaneously with steps 230-260.

At step 230, gear selection is controlled in a gear shifting system 140 through linear actuators 142 and rotational actuators 144 that are coupled to the transmission system of the agricultural equipment 102. At step 240, steering of the agricultural equipment 102 is controlled in a steering control system 150, by measuring a steering angle 152 from detected changes in a magnetic field 154, using one or more steering sensors 119, such as wheel angle sensors 120 that utilize a linear magnetic strip or array to directly measure steering angle 152, to map a linear displacement to an angular output. At step 250, braking of the agricultural equipment 102 may be performed by a braking actuator system 160, where a mechanical braking actuator 162 comprised of multiple mechanical components that automate a braking of the agricultural equipment that allows a freedom of movement for a human operator to also manipulate braking components during a manual operation.

At step 260, operation of associated attachments and implements 104 that are coupled to the agricultural equipment 102 is controlled in an actuation system in which one or more actuators and sensors that provide implements data 124 are actuated by the system controller 106. In this step, and as noted above, sensors provide implements information 124 that enable operators to actuate the attachments or implements 104 in a perform-by-wire actuation, where the actuators coupled thereto are manipulated remotely. Where such attachments and implements 104 are coupled to the agricultural equipment 102, it is to be understood that any type of attachment or implement 104 may be actuated in the toolkit provided in the framework 100 of the present invention, and therefore neither this specification nor the claims are to be limited to any specific type of attachment or implement 104 discussed herein.

The process 200 also includes steps 270, 280 and 290 which govern operation of agricultural equipment 102 and associated attachments and implements 104 in the event that obstacles are detected by the obstacle detection system 170. At step 270, when the obstacle detection system 270 detects an obstacle in the path of the agricultural equipment 102 and/or associated attachments and implements 104 during autonomous operation thereof, a tiered response protocol 172 provides a graduated response sequence 174, which is followed in order to avoid a possible collision. At step 280, if no change in operation occurs from the operator following one or more visual or auditory alerts to the operator of the agricultural equipment 102, the process 200 progresses to active intervention measures in the graduated response sequence 174 to avoid collision with the detected obstacle. At step 290, agricultural equipment 102 and associated attachments and implements 104 are returned to automated control after completion of the graduated response sequence 174, and/or after obstacle collision avoidance.

### Examples of Implementations and Functions

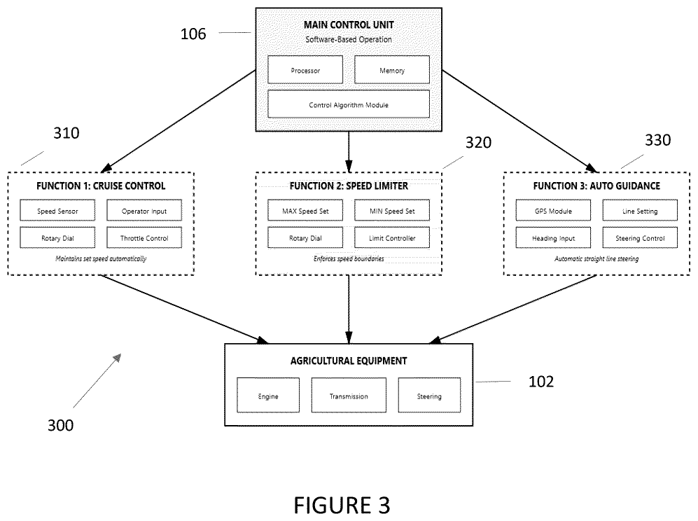

The toolkit and assembly for autonomous software-based operation and control of agricultural equipment 102 and associated attachments and implements 102 coupled thereto according to the present invention enables several functions. FIG. 3 is a flow diagram illustrating several examples of these functions that are possible within the framework 100.

The toolkit and assembly includes a system controller 106 that serves as a main control unit for software-based operation within this framework 100. The main control unit includes one or more processors, memory, and control system algorithms (for example, those embodied in data processing elements 132). The functions enabled by the framework 100 include a cruise control mode 310, where a speed is set by an operator and then maintained automatically; alternatively, a rotary dial or other mechanical mechanism may be utilized to remotely set and monitor the cruise control speed. Another function is setting a maximum or minimum speed, in a speed limiter function 320, that is maintained automatically; alternatively, a rotary dial or other mechanical mechanism may be utilized to set, monitor, and change the maximum or minimum speed. Still another function is straight-line auto guidance function 330, where the operator sets a line location and heading and then has the agricultural equipment 102 steer to that line automatically. These, and other functions as noted below, are additional examples of types of output data 190 that are possible in one or more embodiments of the present invention.

The present invention also enables other functions, such as monitor outputs of pressure sensors in tires agricultural equipment 102 and attachments and implements 104 to check for flats or damage, and integration with a seat switch to ensure safe behavior with or without an operator. Additionally, a maximum left/right curvature may be dynamically changed based on the relative pitch and roll of the front and rear chassis components. Since the relative positions of the tires of agricultural equipment 102 (and attachments and implements 104) change based on the roll and pitch of each section, by dynamically changing the maximum curvature, the smallest turning radius can be achieved in all vehicle positions without compromising the other positions. This enables the smallest curvature without the causing any interference, such as the front and rear tires touching, in all conditions.

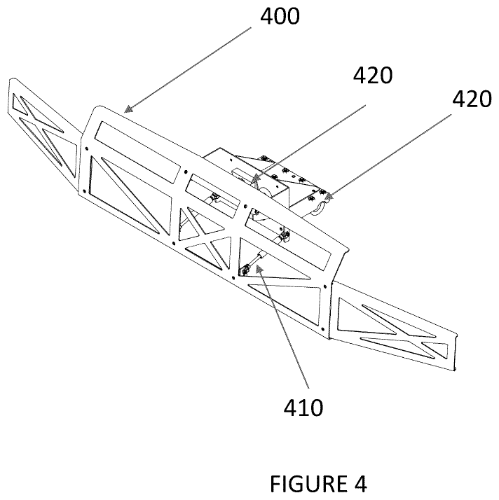

Autonomous software-based operation and control of agricultural equipment 102 and attachments and implements 104 coupled thereto according to the present invention also results in unique fault detection safety innovations. These include an e-stop bumper 400, as illustrated in FIG. 4. The e-stop bumper 400 may be mounted to the front or rear 410 of an implement 104 (or to a vehicle serving as agricultural equipment 102 directly in the front or rear), and may include multiple bumper movement sensors 420. This enables a secondary check that there are no obstacles in the vehicle's path, in addition to the obstacle detection system 170. The framework 100 may also include a Controller Area Network (CAN) connection to the system. Such a CAN connection may be via Ethernet, or using an alternative communication method. Still further, a hydraulic pressure sensor may be implemented that ensures adequate hydraulic flow for movement and steering of the agricultural equipment 102 and attachments and implements 104.

### Mechanical Modifications/Conversions

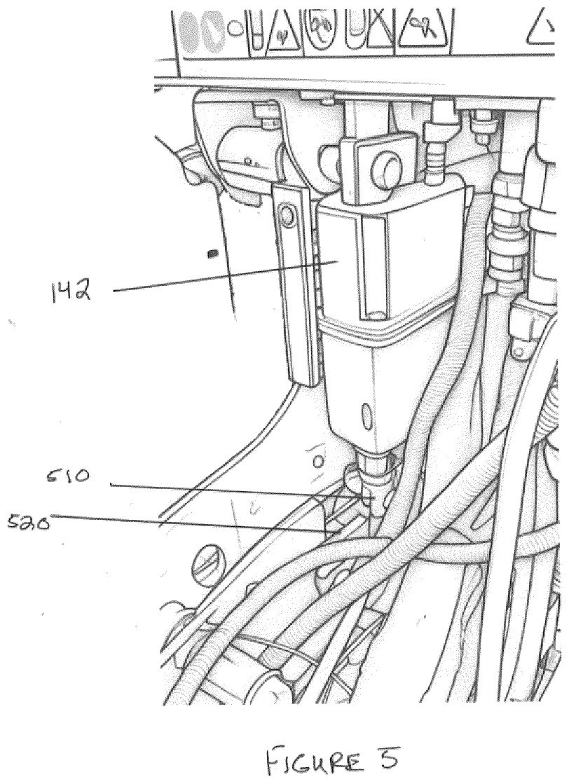

Implementation of the toolkit and assembly, within the framework 100 for autonomous software-based operation and control of agricultural equipment 102 and associated attachments and implements 104 coupled thereto according to the present invention, includes a plurality of mechanical modifications or conversions of conventional equipment. In one embodiment, as shown in FIG. 5, one such modification includes replacement of a lever and/or foot pedal control of a hydraulic swash plate 520 with a linear actuator 142 to control vehicular speed in the gear shifting system 140. The linear actuator 142 is shown in FIG. 5 mounted vertically. It extends, rotating a linkage 510 at the bottom of the photo that in turn moves the swash plate 520 on a hydraulic pump. The linear actuator 142 position is then controlled by the system controller 106, which determines the correct swash plate position based on speed feedback from either the front or rear transmission, together with a desired speed, using either an operator-controlled joystick, a remote joystick, radio buttons or the equivalent on a user interface, or a computer, based on a job plan when in autonomous mode. Alternatively, the swash plate angle may be controlled by coupling either directly or through a geartrain a motor, such as a stepper motor or servo motor.

Speed, as noted above, may be controlled according to one embodiment of the present invention by either a set speed so that the agricultural equipment 102 operates in cruise control mode, or at maximum or minimum speeds (in other words, within a range bounded by such maximum or minimum speeds) set by an operator. This allows for easier control of the agricultural equipment 102 by being able to put the speed input lever or joystick in the maximum position and have the desired speed maintained, making the control easier and the speed steadier. Keeping to a set speed may otherwise be difficult when the agricultural equipment 102 is bouncing around, which can cause the user input to vary as the operator is jostled and their hand moves on the controls.

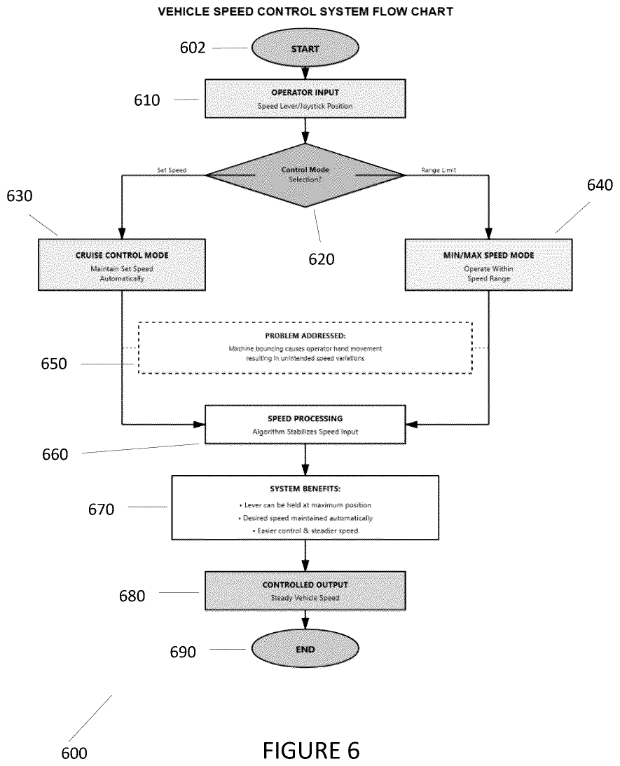

FIG. 6 is a flowchart illustrating steps in an algorithm for providing a vehicular speed control process 600. The problem addressed in this flowchart is expressed at box 650, where the agricultural equipment 102 is bouncing and causes operator hand movement, resulting in unintended speed variations. The process 600 starts at step 602, and receives operator input 610 from a speed lever or joystick. At step 620, a control mode selection occurs, where the operator sets either a cruise control mode 630 (to maintain speed automatically), or a min/max speed mode 640 (to operate at a speed within a particular range).

At step 660, the speed control algorithm stabilizes a speed input for the agricultural equipment 102. System benefits are expressed in box 670 as holding a lever at a maximum or ideal position, automatically maintaining a desired speed, and providing for easier control and steadier speed. At box 680, a controlled output is achieved with a steady vehicular speed, and at a step 690 the algorithm terminates.

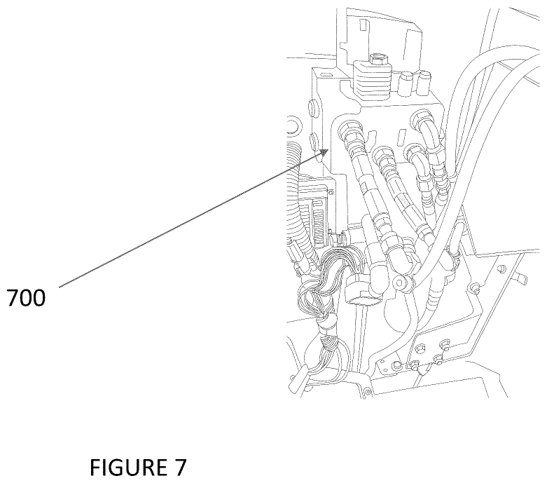

Another mechanical modification includes the addition of an electronically-controlled steering valve 700 as shown in FIG. 7, such as a Danfoss PVED-CLS, PVED-CC, or PVES. The addition of an electronically-controlled steering valve 700 may further include an orbital motor for manual steering input, and a sensor to determine if the steering wheel is moving and the operator wants to take control. Alternatively, an orbital motor may not be used; instead, manual steering input is provided using an e-wheel or joystick.

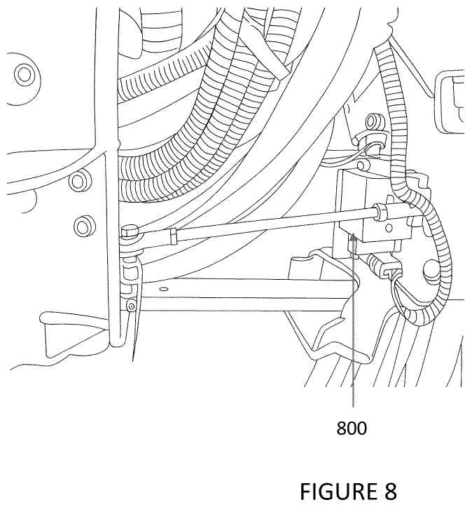

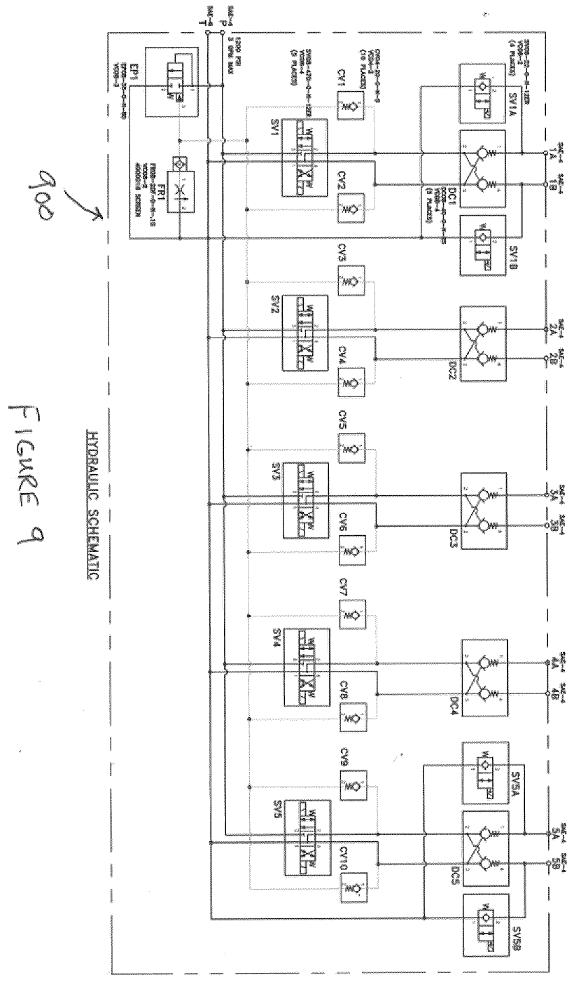

Many other mechanical modifications are possible. These include the addition of an articulation angle sensor 800 as shown in FIG. 8 to determine the relative angle of the front part of the chassis to the rear chassis, and the addition of an electronically-controlled switch used in series with an operator-controlled switch to control the front power take-off. One or more solenoids may also be added to control hydraulic flow direction, including a float mode, of all of the hydraulic valves. FIG. 9 is schematic 900 illustrating a manifold with solenoid-controlled valves so that the hydraulic remotes on the agricultural equipment 102 are able to be electronically controlled in the framework 100.

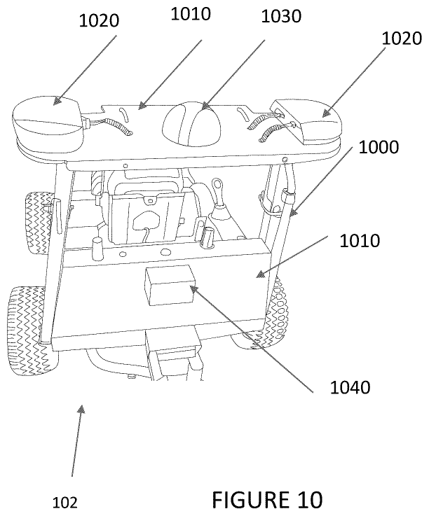

Achieving autonomous software control of machines in the present invention may further include adding one or more connection points for implements 104. FIG. 10 illustrates these connection points, as well various elements that are associated with the implements 104 as described further herein.

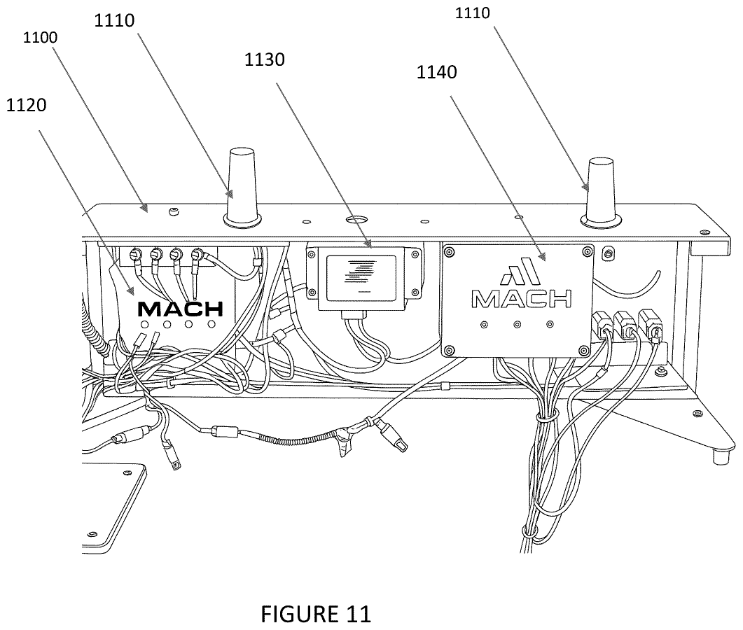

The connection points enable both implement sensing and implement control in the framework 100. Connection points may be implemented on mounting platform(s) 1010, for adding mounts for Global Positioning Systems (GPS) 1020 and types of other antennas 1030 to a rollbar 1000 on the implement 104. Sensors, such as rear-facing sensor 1040, may also be added to the mounting platform 1010 on the implement 104. In FIG. 11, the toolkit adds an enclosure 1100 to mount electronics to the rollbar 1000 of an implement 104, in each case without affecting its structural integrity (for example, without having to remove or move antennas 1110). Such electronics that may be placed inside the enclosure 1100 include a gateway module 1120, a remote control interface 1130, and a vehicle control module 1140.

Achieving autonomous software control of agricultural equipment 102 and associated attachments and implements 104 may also include addition of a joystick option. The joystick 114 is used to provide user inputs 111 for control of both the vehicle steering (instead of a steering wheel), and the vehicle speed.

### Sensors

The present invention, as noted above, also includes the addition of different types of sensors. For example, an electronic inertial measurement unit (IMU) may be utilized to determine vehicular roll and pitch. Information from this IMU may be used to display to, and warn, the operator when safe limits have been exceeded, both onboard the machine and on a remote user interface. This information may also be utilized to take evasive maneuvers when operating in an autonomous mode.

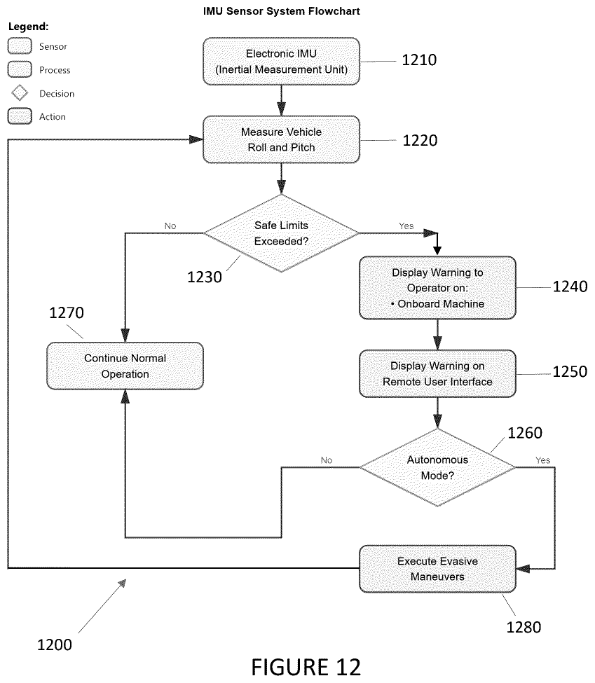

FIG. 12 is a flow diagram illustrating steps in a process 1200 where data from an electronic inertial measurement unit 1210 is analyzed. At step 1220, the electronic IMU 1210 measures vehicular roll and pitch, and step 1230, the system controller 106 analyzes this information to determine if safe limits have been exceeded. If they have been exceeded, at step 1240 the process 1200 displays a warning to operator, for example on a display or interface onboard the agricultural equipment 102 itself, or at 1250, on a remote user interface. At step 1260, if the agricultural equipment 102 is in autonomous mode, the process 1200 to executes evasive maneuvers 1280 to return to safe limits, and returns to measurement of roll and pitch at step 1220. If safe limits are not exceeded at step 1230, the process 1200 continues with performance of normal operation of the agricultural equipment 102 at step 1270.

Alternatively, the relative position of two GPS units 1020 as shown in FIG. 10 may also be used to generate information that drives operator decision-making with regard to vehicular roll and pitch. Independent tilt sensors on the front and rear chassis may also be applied to independently measure and display the roll and pitch of the front and rear of both agricultural equipment 102, and attachments and implements 104 coupled thereto.

Sensors may also be added to the axles of the agricultural equipment 102, and attachments and implements 104 coupled thereto to determine the weight distribution on each corner thereof. This information may be used to adjust the weight transfer front to back, to ensure all wheels have proper traction. Sensors may also be deployed to measure vehicular roll, pitch, and/or yaw of the front and rear chassis to estimate the weight distribution at each wheel in order to dynamically change the front-to-rear weight transfer to ensure all wheels have proper traction.

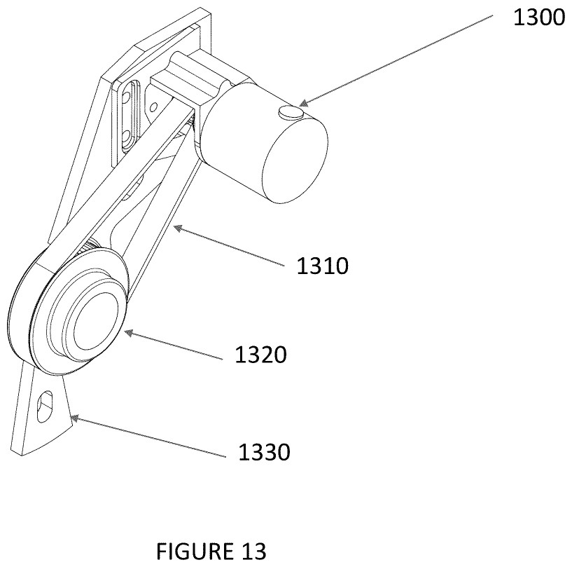

FIG. 13 illustrates an encoder 1300, which may also be used to measure the front and/or rear transmission speed of agricultural equipment 102. This information may be used for closed-loop control of the vehicle speed. The encoder 1300 may include a belt 1310, and a gear 1320 attached to transmission output shaft. One or more brackets 1330 may be used to couple the encoder 1300 to the agricultural equipment 102. Other sensors that may be added include a rotation sensor and/or tilt sensors to measure the 3-pt arm(s) position and the front implement arms position.

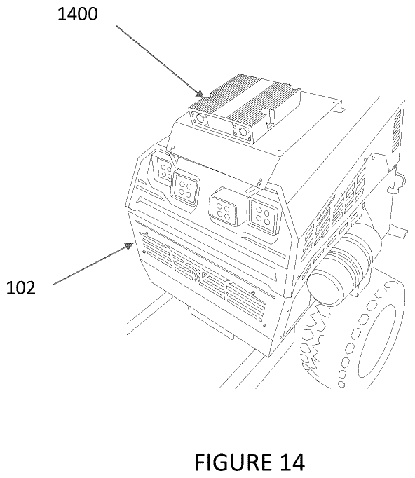

Other sensors may be added for autonomous operation of both agricultural equipment 102 and coupled attachments and implements 104 that are able to observe the front (in front of), rear (behind) and the sides of the vehicle, to determine if obstacles are present. FIG. 14 illustrates a front-facing sensor 1400, and FIG. 10 illustrates a rear-facing sensor 1040 placed on an implement 104. Types of sensors for front-facing sensor 1400 and rear-facing sensor 1040 may include one or more of vision sensors (such as cameras capable collecting still images or video), single and multi-plane lidar sensors, force-activated bumpers, and radar sensors.

### Agricultural Equipment and Attachments/implements

As noted above, agricultural equipment 102 may be any type of vehicle or machine that serves as primary equipment in an agricultural environment, such as tractors (vehicles generally used to pull other machines), combines (vehicles used for specifically designed for multiple functions in relation to grain crops, such as wheat, corn, soybeans, barley, etc., that include threshing and cleaning systems and produce separated grain ready for storage or transport), and more broadly, harvesting machines such as those that gathers crops from the field and which may or may not include processing capabilities (including specific types of harvesters such as forage, cotton, potato, sugar beet, and fruit harvesters. Other types of primary equipment may include tillage machines, crop planting machines, irrigation and fertilizer machines, and any other machine that is self-propelled and operated by an operator in a cab thereon. There are many examples of such primary equipment, and it is to be understood that the present invention (and neither the specification, nor any claims herein) is not to be limited to any one specific vehicle or machine referred to herein as agricultural equipment 102.

Attachments and implements 104 include any type of agricultural machine that is not self-propelled, meaning that it does not have an independent operator and is coupled to a piece of primary equipment. There are many examples of such machines, and it is to be understood that the present invention (and neither the specification, nor any claims herein) is not to be limited to any one specific machine or type of machine referred to herein as an attachment or implement 104.

Nonetheless, there are many examples of attachments and implements 104. These include tillage implements, such as those for primary tillage (moldboard plows, chisel plows, disk plows, and subsoilers), and those for secondary tillage (disk harrows, field cultivators, spring-tooth harrows, and rotary tillers). Attachments and implements 104 may also include planting equipment for seed placement, such as grain drills, planters, no-till drills, and broadcast seeders, and specialty devices such as potato planters (that handle seed potatoes with specific spacing requirements) and transplanters (that set greenhouse-grown seedlings into fields).

Harvesting-related attachments and implements 104 may include combine headers, such as grain headers, corn headers, flex headers, and draper headers, and forage equipment, such as mowers and mower-conditioners, tedders, rakes, and balers. Crop maintenance attachments and implements 104 may include cultivation equipment, such as row cultivators: rotary hoes, and rolling cultivators, and spraying equipment, such as field sprayers, band sprayers, and air-blast sprayers. Other attachments and implements 104 include materials handling machines such as those for loading, transport, and general movement, including front-end loaders, manure spreaders, grain carts, grapple buckets (for handling loose materials like brush and debris) and snow blowers.

### Control Functions

The present invention also enables implementation of a plurality of additional control functions, at least from making the complete vehicle hydraulics autonomously controlled by software. These control functions may vary by the type of agricultural equipment 102 or attachment or implement 104 to which the present invention is applied, as follows.

On exemplary implement 104 coupled to agricultural equipment 102 is a boom mower. In the case of an attachment or implement 104 such as a boom mower, the present invention enables a control function that allows the distance of mower blades to either the ground or the vegetation being cut to be set and then automatically controlled. Sensors, such as for example radar, stereo vision, ultrasonics, or lidar may be used to sense the distance of cutting blades to object, and then control algorithms (written to automatically maintain that distance) are applied to electronically open and close solenoids to control the flow of hydraulic fluid to the motors controlling the cutter bar position.

Another control function for boom mowers is automatic control of hydraulic motors so that when adjusting the position on one axis, the other axis is not affected. For instance, with current boom geometry, when the height of the blade is adjusted, the lateral position changes. An algorithm(s) may be applied to control the flow of hydraulic fluid to move the motor controlling the lateral position, so that the lateral position is maintained when the height is changed, making the boom mower easier to control.

Other automated controls are also possible. By electronically controlling the hydraulics, the boom mower position may be controlled with a joystick 114 instead of levers, making its operation easier. The addition of rotation or angle sensors to the boom arms enable an operator to maintain a position as desired by a user, either absolute or relative to the environment. The boom mower may be put into an automation mode where the boom arm and cutter positions are automatically controlled based on an absolute position (based on GPS or localization sensor data), or a programmed job that specifies the cut position at different geographic locations. Alternatively, a machine learning approach may be utilized that senses the environment and in real-time creates a cutting plan. In such an approach, one or more artificial intelligence-based algorithms (for example, neural networks that take, as inputs, at least such environment data) may be developed and applied to generate such a real-time cutting plan.

In the case of a pulled or mounted mower, the present invention enables several control functions for automatically slowing or speeding up the agricultural equipment 102. One such control function automatically slows or speeds up the agricultural equipment 102 based on the mower blade rotation speed. Another control function automatically slows or speeds up the agricultural equipment 102 based on the engine rpm, which may be affected by the load on the mower. Yet another automatically slows or speeds up the agricultural equipment 102 based on the quantity of vegetation sensed by vision sensors, lidar, or radar systems.

The present invention enables several control functions for automatically raising or lowering the mower position for pulled or mounted mowers. These include automatically raising or lowering the motor position based on the mower blade rotation speed, automatically raising or lowering the mower position based on the engine rpm (which may also be affected by the load on the mower), and automatically raising or lowering the mower position based on the quantity of vegetation sensed vision sensors, lidar, or radar systems.

While mowing, the present invention may record images for use in real-time or in post operation to analyze characteristics of interest such as weed pressure, stress due to moisture level, and ground disturbance due to animal pressure such as moles or gophers. This may be used for creating an alert when such characteristics are detected, for creating a map of the characteristics for later review, and for creating reports showing the severity of the issues and location of the characteristics. Recorded images of an operation may also be utilized as proof that the job was completed, and documentation and evidence of any issues that may have occurred (or documentation and evidence that claimed issues did not happen).

Control functions may also be implemented in the case of a pulled or mounted mower to control the mower position/height, an on/off status, a blade speed, or any other setting. Such control may be based on a predetermined prescription map for the job being performed.

When a mounted mower (mounted in front of or at the rear of agricultural equipment 102 such as a tractor) is in place, on some terrain the mower can create a bridge between it and the opposite wheels, causing the intermediate wheels to have less downforce and thus less traction. This can be determined by ground pressure sensors or by sensors measuring the relative location of the tractor chassis and wheel components and the mower. This condition can cause lack of steering authority (traction), which can cause the agricultural equipment 102 not to go where directed. This condition can be sensed, and a control function may be implemented to automatically change the mower position in order to maintain the required steering authority in such conditions.

In the case of a front bucket, the present invention enables several control functions relative to a bucket position or height. These include control functions for determining the bucket position based on the front implement arms position and bucket tilt; determining the bucket position based on the bucket tilt relative to the front chassis tilt; and maintaining a set bucket height, by first using the vehicle GPS height information and the relative position of the bucket to the GPS sensor, and then controlling the bucket height based on a predefined height or a map of height plotted against GPS latitude and longitude.

In the case of an attached or pulled scraper blade, additional control functions are possible. These at least include maintaining a set blade height; this occurs by first using the vehicle GPS height information and the relative position of the blade to the GPS sensor, and then controlling the bucket height based on a predefined height or a map of height plotted against GPS latitude and longitude.

In the case of a snow blower or blade, additional control functions are further possible. These at least include automatically controlling the snow blower or blade position relative to the ground. This may occur based on the vehicle tilt, and/or sensing the distance of the blower or blade relative to the ground. The height of the snow blower or blade may also be controlled via a map of the area that includes the height of the ground that the blower/blade is going over.

### User Interface Enhancements

The present invention may also include enhancements to one or more user interfaces to effect autonomous operation based on the modifications and control functions enabled as discussed above. These user interface enhancements may include providing input selectors (for example, as a ‘radio’ button) to allow the agricultural equipment 102 and coupled attachments and implements 104 to be autonomously or remotely controlled. Other user interface modifications include providing speed input buttons to electronically control the engine speed of the agricultural equipment 102.

There are several unique aspects to an enhanced user interface for autonomous software operation of agricultural equipment 102 and attachments and implements 104 coupled thereto in the present invention. These may include a visualization of the roll of front chassis and rear chassis separately (instead of normal user interface in which just one gauge for the entire vehicle's roll and pitch is provided). Enhancements to a user interface also enable electronically relaying sensor information such as fuel level, engine rpm, engine temperature, and hydraulic pressure and temperature, so that they can be shown remotely from the vehicle or on the vehicle, and sending vehicle status, job quality, and terrain and vegetation information (such as the grass characteristics) to local computer memory to be saved and also to the cloud to be saved off of the agricultural equipment 102.

The present invention may also provide a vehicle dashboard that communicates with the agricultural equipment 102 wirelessly so that it can be used on the agricultural equipment 102 or taken off and used remotely, and a docking station for a tablet on the dash of the agricultural equipment 102 that can be removed by the operator.

### Artificial Intelligence Integrations

The present invention includes, in one or more aspects thereof, the use of artificial intelligence-based models. These models may apply techniques of machine learning, such as supervised learning and unsupervised learning, as well as one or more instantiations of neural networks to continually enhance the modeling of the input data 110 in one or more of the data processing modules 132 of the framework 100, by developing and understanding relationships between various types of information. These artificial intelligence-based models may include standardized models, and may also include one or more models customized according to proprietary formulas. Regardless, the artificial intelligence-based models are comprised, at least in part, of algorithms that apply different mathematical approaches to analyzing information and generating outputs of the framework 100 described herein.

As noted above, the present invention may include implementation of one or more artificial intelligence-based algorithms, in applications of machine learning techniques for analyzing data relative to some aspect of autonomous software-based operation and control of agricultural equipment 102 and associated attachments and implements 104. Artificial intelligence-based algorithms in the present invention may include many types of machine learning techniques. These may include, but are not limited to, k-nearest neighbor (KNN), logistic regression, support vector machines or networks (SVM), and one or more neural networks.

Neural networks may be applied in the present invention to identify and model appropriate relationships between data points to provide a more accurate understanding of various characteristics associated with autonomous operation and control of agricultural equipment 102 and associated attachments and implements 104. For example, neural networks may be applied to develop more accurate understandings of the environment in which agricultural equipment 102 and associated attachments and implements 104 are being operated; as noted above, this may include developing a real-time cutting plan for implements such as boom mowers, which take in account predictions and simulations of the immediate environmental conditions (such as the presence and extent of vegetation, the presence of people or animals nearby, etc.)

There are many types of neural networks, which are computing systems that “learn” to perform tasks in a supervised manner without being programmed with task-specific rules, based on examples. Neural networks are generally comprised of nodes, which are computational units having one or more biased input/output connections. Such biased connections act as transfer (or activation) functions that combine inputs and outputs in some way. Neural networks are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers perform different transformations on their various inputs, using different mathematical calculations or functions. Signals travel between layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise a neural network can change over time as a system improves itself.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, the present invention may have many different configurations of different types of sensing systems, depending for example upon the environment in which sensing is performed, and type of attachment or implement 104 that is being utilized in conjunction with agricultural equipment 102. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed above even when not initially claimed in such combinations.

### Non-Agricultural Implementations

It is to be understood that the toolkit and assembly of the present invention, and the framework 100 within which the toolkit and assembly are implemented, need not be limited only to agricultural applications, or agricultural equipment 102 and attachments and implements 104 for agricultural use. For example, the present invention may be implemented for removal of snow, such as where snow blowers or blades are the implements 104, or for other situations such as leveling payment or a driveway, and for removal of debris from roads (paved or otherwise). Any type of appropriate vehicle may therefore be used in such situations, and need not be agricultural in nature. Therefore, it is to be further understood that such applications are within the scope of the present invention, and that neither the present invention, specification, nor any claims are not to be expressly limited agricultural environments, unless so stated.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. An assembly for conversion of conventional agricultural equipment for autonomous operation, comprising:
a gear shifting system to control a speed of agricultural equipment, comprised of a linear actuator that replaces a manual control of a hydraulic swash plate, and a rotational actuator that enables mechanical tolerance to allow for automatic gear adjustment during engagement for rotational freedom;
a steering control system having at least one wheel angle sensor to measure a steering angle and detect magnetic field changes, to enable automated steering of the agricultural equipment;
a brake actuator system comprised of a mechanical brake actuator;
an actuation system coupled to one or more implements associated with the agricultural equipment;
an obstacle detection system that initiates a graduated response sequence when a collision hazard is detected for the agricultural equipment and the one or more implements; and
an override protection system that overrides an automated control of the agricultural equipment and the one or more implements in the graduated response sequence when a collision with an obstacle is identified.

2. The assembly of claim 1, wherein one or more gear sensors provide information that enables a system controller to monitor and track a position of the agricultural equipment, and monitor and track a rotational force of the agricultural equipment.

3. The assembly of claim 2, wherein the one or more gear sensors that enable a system controller to monitor and track the position include one or more Hall-effect or optical encoders and are mounted on one or more linear actuators to detect the exact position of a shift mechanism and applied forces.

4. The assembly of claim 2, wherein the one or more gear sensors that enable a system controller to monitor and track the rotational force include one or more strain gauges that are mounted on one or more rotational actuators to perform minor gear rotations within a mechanical tolerance to maintain gear meshing.

5. The assembly of claim 1, wherein the at least one wheel angle sensor enables a system controller to compute a steering angle through a linear magnetic scale to provide a direct measurement mechanism, in which a magnetic reader head, fixed to the moving steering component, detects the changes in the magnetic field to map a linear displacement to an angular output.

6. The assembly of claim 1, wherein the actuation system coupled to the one or more implements associated with the agricultural equipment includes one or more mechanical actuators that enable the automated control of the one or more implements, and one or more sensors that provide information characterizing an orientation and performance of the one or more implements relative to the agricultural equipment.

7. The assembly of claim 1, wherein the mechanical brake actuator includes a plurality of mechanical components that automate a braking of the agricultural equipment that allows a freedom of movement for a human operator to also manipulate braking components during a manual operation.

8. The assembly of claim 1, wherein the graduated response sequence provides one or more visual or auditory alerts to an operator of the agricultural equipment, and progresses to active intervention measures if no change in operation occurs from the operator.

9. The assembly of claim 8, wherein the active intervention measures include an override function from the intelligent override protection system that temporarily overrides operator inputs to prevent impact in response to an imminent collision with a detected obstacle, the active intervention measures including modulating one or more throttle, brake, and steering inputs for the agricultural equipment and the associated implements.

10. The assembly of claim 1, wherein the obstacle detection system includes one or both of camera systems and radar systems to detect obstacles in a path of the agricultural equipment and the associated implements.

11. A method for converting conventional agricultural equipment for autonomous operation, comprising:
controlling a speed of agricultural equipment, in a gear shifting system comprised of a linear actuator that replaces a manual control of a hydraulic swash plate, and a rotational actuator that enables mechanical tolerance to allow for automatic gear adjustment during engagement for rotational freedom;
controlling a steering of the agricultural equipment, in a steering control system having at least one wheel angle sensor that measures a steering angle and detects magnetic field changes;
controlling a braking of the agricultural equipment, in a brake actuator system comprised of a mechanical brake actuator;
controlling an operation of one or more implements associated with the agricultural equipment;
initiating a graduated response sequence when a collision hazard is detected for the agricultural equipment and the one or more associated implements, in an obstacle detection system; and
overriding an automated control of the agricultural equipment and the one or more associated implements in the graduated response sequence when a collision with an obstacle is identified, in an intelligent override protection system.

12. The method of claim 11, wherein one or more gear sensors provide information that enables a system controller to monitor and track a position of the agricultural equipment, and monitor and track a rotational force of the agricultural equipment.

13. The method of claim 12, wherein the one or more gear sensors that enable a system controller to monitor and track the position include one or more Hall-effect or optical encoders and are mounted on one or more linear actuators to detect the exact position of a shift mechanism and applied forces.

14. The method of claim 12, wherein the one or more gear sensors that enable a system controller to monitor and track the rotational force include one or more strain gauges that are mounted on one or more rotational actuators to perform minor gear rotations within a mechanical tolerance to maintain gear meshing.

15. The method of claim 11, wherein the controlling the steering of the agricultural equipment further includes computing a steering angle through a linear magnetic scale to provide a direct measurement mechanism, in which a magnetic reader head, fixed to the moving steering component, detects the changes in the magnetic field to map a linear displacement to an angular output.

16. The method of claim 11, wherein one or more mechanical actuators enable the automated control of the one or more implements, and one or more sensors provide information characterizing an orientation and performance of the one or more implements relative to the agricultural equipment.

17. The method of claim 11, wherein the mechanical brake actuator includes a plurality of mechanical components that automate a braking of the agricultural equipment that allows a freedom of movement for a human operator to also manipulate braking components during a manual operation.

18. The method of claim 11, further comprising providing one or more visual or auditory alerts to an operator of the agricultural equipment, and progressing to active intervention measures if no change in operation occurs from the operator.

19. The method of claim 18, wherein the active intervention measures include an override function from the intelligent override protection system that temporarily overrides operator inputs to prevent impact in response to an imminent collision with a detected obstacle, the active intervention measures including modulating one or more throttle, brake, and steering inputs for the agricultural equipment and the associated implements.

20. The method of claim 11, further comprising receiving information from one or both of camera systems and radar systems in the obstacle detection system to detect obstacles in a path of the agricultural equipment and the associated implements.

21. A method, comprising:
receiving user inputs relative to a conversion of conventional agricultural equipment and associated implements into an automated operation of the agricultural equipment and associated implements;
actuating a plurality of systems that perform an automated control of the agricultural equipment and the one or more implements in response to the user inputs, the plurality of systems:
controlling a speed of the agricultural equipment,
controlling a steering of the agricultural equipment,
controlling a braking of the agricultural equipment,
controlling an operation of the one or more implements,
detecting one or more obstacles to the agricultural equipment and the associated implements, and
overriding an automated control of the agricultural equipment and the one or more implements when a collision with the one or more obstacles is identified;
generating one or more signals for automatically operating the conventional agricultural equipment and associated implements; and
performing the automated operation of the agricultural equipment and associated implements, in response to the user inputs.

22. The method of claim 21, wherein the controlling the speed of the agricultural equipment occurs within a gear shifting system comprised of a linear actuator that replaces a manual control of a hydraulic swash plate, and a rotational actuator that enables mechanical tolerance to allow for automatic gear adjustment during engagement for rotational freedom, the gear shifting system further comprising one or more gear sensors provide information that enables a system controller to monitor and track a position of the agricultural equipment, and monitor and track a rotational force of the agricultural equipment.

23. The method of claim 22, wherein the one or more gear sensors that enable a system controller to monitor and track the position include one or more Hall-effect or optical encoders and are mounted on one or more linear actuators to detect the exact position of a shift mechanism and applied forces.

24. The method of claim 22, wherein the one or more gear sensors that enable a system controller to monitor and track the rotational force include one or more strain gauges that are mounted on one or more rotational actuators to perform minor gear rotations within a mechanical tolerance to maintain gear meshing.

25. The method of claim 21, wherein the controlling the steering of the agricultural equipment occurs within a steering control system having at least one wheel angle sensor to measure a steering angle and detect magnetic field changes, to enable automated steering of the agricultural equipment, wherein the at least one wheel angle sensor enables a system controller to compute a steering angle through a linear magnetic scale to provide a direct measurement mechanism, in which a magnetic reader head, fixed to the moving steering component, detects the changes in the magnetic field to map a linear displacement to an angular output.

26. The method of claim 21, wherein the controlling the braking of the agricultural equipment occurs within a brake actuator system comprised of a mechanical brake actuator, wherein the mechanical brake actuator includes a plurality of mechanical components that automate a braking of the agricultural equipment that allows a freedom of movement for a human operator to also manipulate braking components during a manual operation.

27. The method of claim 21, wherein the controlling the operation of the one or more implements occurs within an actuation system coupled to one or more implements associated with the agricultural equipment, wherein the actuation system coupled to the one or more implements associated with the agricultural equipment includes one or more mechanical actuators that enable the automated control of the one or more implements, and one or more sensors that provide information characterizing an orientation and performance of the one or more implements relative to the agricultural equipment.

28. The method of claim 21, wherein the obstacle detection system initiates a graduated response sequence when a collision hazard is detected for the agricultural equipment and the one or more implements, the graduated response sequence providing one or more visual or auditory alerts to an operator of the agricultural equipment, and progresses to active intervention measures if no change in operation occurs from the operator.

29. The method of claim 28, wherein the active intervention measures include an override function from the intelligent override protection system that temporarily overrides operator inputs to prevent impact in response to an imminent collision with a detected obstacle, the active intervention measures including modulating one or more throttle, brake, and steering inputs for the agricultural equipment and the associated implements.

30. The method of claim 21, wherein the obstacle detection system includes one or both of camera systems and radar systems to detect the one or more obstacles in a path of the agricultural equipment and the associated implements.
